(19) United States
(12) Patent Application Publication
(10) Pub. No.: US 2015/0212378 A1
(43) Pub. Date: Jul. 30, 2015

(54) DISPLAY DEVICE AND MANUFACTURING METHOD THEREOF

(71) Applicant: SAMSUNG ELECTRONICS CO., LTD., Suwon-si (KR)

(72) Inventors: Eui-Dong HWANG, Bucheon-si (KR); Jeong Ho BANG, Seoul (KR); Yong Hwan PARK, Anyang-si (KR)

(73) Assignee: SAMSUNG ELECTRONICS CO., LTD., Suwon-si (KR)

(21) Appl. No.: 14/606,628

(22) Filed: Jan. 27, 2015

(30) Foreign Application Priority Data
Jan. 27, 2014 (KR) 10-2014-0009539

(51) Int. Cl. G02F 1/1362; G02F 1/1341

(52) U.S. Cl. CPC G02F 1/136204; G02F 1/136286; G02F 1/1341

(57) ABSTRACT

A display device and manufacturing method thereof. The display device includes a first substrate and a second substrate formed to face each other; a liquid crystal layer between the first and second substrates; a plurality of gate wirings and data wirings intersecting each other to form a plurality of pixel regions on the second substrate; and a first ground wiring formed on the first substrate configured to block a surge voltage from being applied to the pixel regions.

### CROSS-REFERENCE TO RELATED APPLICATION

This application claims priority under 35 U.S.C. §119(a) from a Korean patent application filed on Jan. 27, 2014 in the Korean Intellectual Property Office and assigned Serial No. 10-2014-0009539, the entire disclosure of which is incorporated hereby incorporated by reference.

### FIELD

Methods and apparatuses consistent with exemplary embodiments relate to a display device and a manufacturing method of the display device.

### BACKGROUND

A display device displays visual and stereographic image information.

With recent development of high performance flat display devices, possible installation space of the display device is less constrained due to reduced weight and volume as compared to Cathode Ray Tubes (CRTs), a large-screen image is easily implemented, and a high image quality is provided.

Display devices may be divided into displays adopting transmissive methods and displays adopting reflective methods.

Display devices adopting the transmissive method use, e.g., backlight units that include light sources to emit light. A representative example of the display device adopting the transmissive method is the Liquid Crystal Display (LCD).

### SUMMARY

The present disclosure provides a display device and manufacturing method of the display device, by which ground wiring is configured to block static electricity from being input to pixel regions.

In accordance with an aspect of an exemplary embodiment, a display device is provided. The display device includes a first substrate and a second substrate formed to face each other; a liquid crystal layer between the first substrate and the second substrate; a plurality of gate wirings and data wirings intersecting each other to form a plurality of pixel regions on the second substrate; and a first ground wiring formed on the first substrate configured to block an external surge voltage from being applied to the pixel regions.

The first ground wiring may be formed along the edge of the first substrate.

The first substrate may include a common electrode configured to receive a voltage, the second substrate may include a plurality of pixel electrodes formed in the pixel regions and configured to produce electric fields with the common electrode, and the display device may further include a plurality of short points for connecting the common electrode and the pixel electrodes.

The first ground wiring may be formed closer to the edge of the first substrate than to the short points.

The first ground wiring may be formed by patterning along the edge of the common electrode.

The first substrate may include an isolator configured to isolate the first ground wiring from the common electrode.

The first ground wiring may be configured to absorb a surge voltage.

The display device may further include ground short points configured to deliver the surge voltage absorbed by the first ground wiring to the second substrate.

The display device may further include data drivers connected to the plurality of data wirings configured to provide data signals to the plurality of data wirings; and a second ground wiring that connects ground electrodes of the data drivers and the ground short points.

The first ground wiring may be connected to a plurality of ground electrodes of the data drivers to discharge the surge voltage.

In accordance with another aspect of an exemplary embodiment, a manufacturing method of a display device is provided. The manufacturing method includes filling a liquid crystal layer between a first substrate and a second substrate that includes pixel regions; and forming, on the first substrate, a first ground wiring configured to block an external surge voltage from being applied to the pixel regions.

Forming the first ground wiring may include forming the first ground wiring along an edge of the first substrate.

The manufacturing method may further include forming short points for connecting the common electrode and the pixel electrodes, and first substrate may include a common electrode to which a voltage is applied, the second substrate may include pixel electrodes formed in the pixel regions to produce electric fields with the common electrode.

Forming the first ground wiring may include forming the first ground wiring along an edge of the first substrate closer to the edge than to the short points.

Forming the first ground wiring may include patterning along the edge of the common electrode.

Forming the first ground wiring may include forming an isolator configured to isolate the first ground wiring and the common electrode.

Forming the first ground wiring may include forming the first ground wiring to absorb the surge voltage.

The manufacturing method may further include forming ground short points configured to deliver the surge voltage absorbed by the first ground wiring to the second substrate.

The manufacturing method may further include forming, on the second substrate, data drivers configured to provide data signals to the pixel regions; and forming a second ground wiring that connects ground electrodes of the data drivers and the ground short points.

In accordance with another aspect of an exemplary embodiment, a display device includes a first substrate including a plurality of color filters and a ground wiring along a perimeter of the first substrate; and a second substrate including a plurality of data drivers, a plurality of gate lines extending in a first direction, a plurality of data lines extending in a second direction perpendicular to the first direction and a second ground short point. The first substrate is formed opposite the second substrate and the ground wiring is connected to the first second ground short point and the plurality of data drivers.

### BRIEF DESCRIPTION OF THE DRAWINGS

The above and/or other aspects will become more apparent by describing in detail certain exemplary embodiments with reference to the attached drawings in which:

FIG. 1 is a perspective view of a display device, according to an exemplary embodiment;

FIG. 2 is a structure of a main body of a display device, according to an exemplary embodiment;

FIG. 3 schematically illustrates a display panel of a display device, according to an exemplary embodiment;

FIG. 4 is an exploded view of a display panel of a display device, according to an exemplary embodiment;

FIG. 5 is a perspective view of a first substrate of a display panel of a display device, according to an exemplary embodiment;

FIGS. 6A to 6D are exploded views of a display panel illustrating a path through which a surge voltage is discharged;

FIG. 7 is a perspective view of a first substrate of a display panel of a display device, according to another exemplary embodiment;

FIG. 8 is a flowchart illustrating a method for manufacturing a display device, according to an exemplary embodiment; and

FIG. 9 is a flowchart illustrating a method for manufacturing a display device, according to another exemplary embodiment.

### DETAILED DESCRIPTION OF EXEMPLARY EMBODIMENTS

The present disclosure will now be described more fully with reference to the accompanying drawings, in which exemplary embodiments are shown. The disclosure may, however, be embodied in many different forms and should not be construed as being limited to the exemplary embodiments set forth herein; rather, these exemplary embodiments are provided so that this disclosure will be thorough and complete, and will fully convey the concept to those skilled in the art. Like reference numerals in the drawings denote like elements.

Although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure. The terminology used herein is for the purpose of describing particular embodiments only and is not intended to be limiting of the invention. It is to be understood that the singular forms “a,” “an,” and “the” include plural references unless the context clearly dictates otherwise.

The term “include (or including)” or “comprise (or comprising)” is inclusive or open-ended and does not exclude additional, unrecited elements or method steps. “Unit”, “module”, “block”, etc. used herein each represent a unit for handling at least one function or operation, and may be implemented in hardware, software, or a combination thereof.

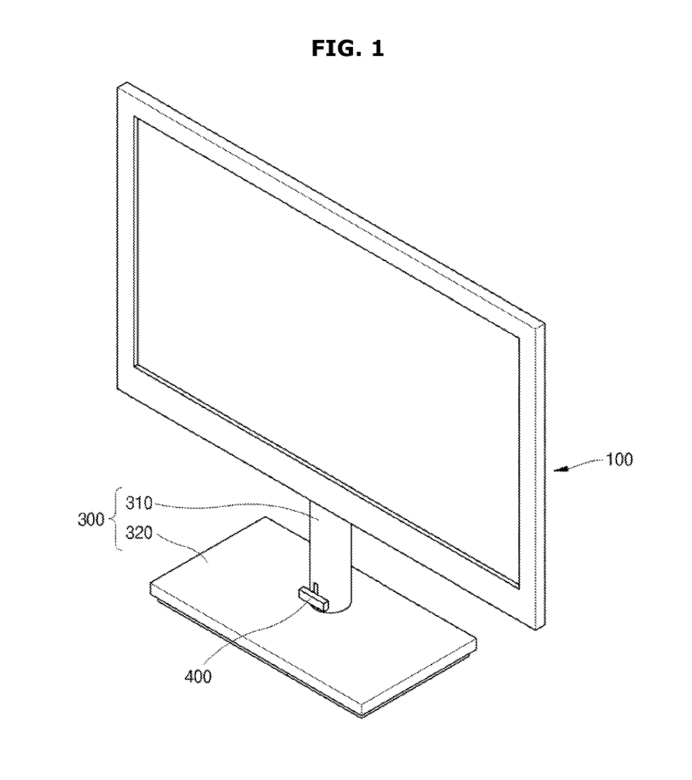

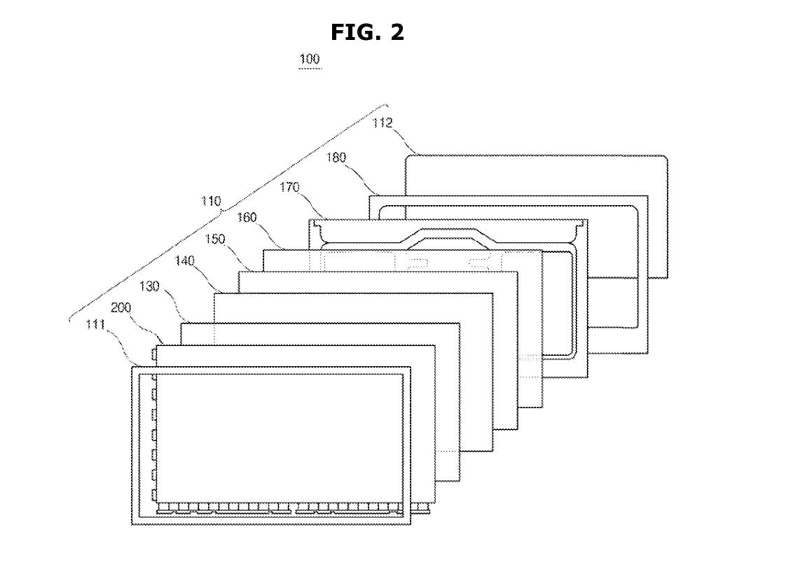

FIG. 1 is a perspective view of a display device, according to an exemplary embodiment. FIG. 2 is a structure of a main body of a display device, according to an exemplary embodiment.

As shown in FIG. 1, a display device may include a main body 100 that displays an image and outputs sound; a stand 300 that includes a support 310 that extends from a base 320 at the bottom of the main body 100 to support the main body 100; and a multimedia module 400 that is mounted on the stand 300 to obtain images and sound from a user or the surroundings and deliver the images and sound to the main body 100. Sound may be output through the multimedia module 400 or from an external device.

The display device may include a television, a monitor, or the like.

As shown in FIG. 2, the main body 100 may include a case 110, a display panel 200, a support member 130, an optical sheet 140, a light guide plate 150, a light source (or light emitting diodes (LED)) 160, a chassis 170, and a reinforcement member 180.

The case 110 may include a bezel 111 and a cover 112.

The bezel 111 and the cover 112 may be detachably combined. An accommodation space may be formed when the bezel 111 and the cover 112 are combined.

Specifically, the case 110 may accommodate and protect the display panel 200, the support member 130, the optical sheet 140, the light guide plate 150, the light source 160, the chassis 170, and the reinforcement member 180.

The support member 130 may support the display panel 200 arranged between the support member 130 and the bezel 111, and also supports the optical sheet 140, the light guide plate 150, and the light source 160 arranged between the support member 130 and the cover 112.

The optical sheet 140 may supply light to the display panel 200 by enhancing light supplied from the light guide plate 150. Specifically, the optical sheet 140 may enhance light from LEDs of the light source 160 and normalize the brightness across the display panel 200.

The light guide plate 150 may cause the light from the LEDs of the light source 160 to be incident upon the display panel 200 in an even manner.

The light source 160 may be located on a side or back of the light guide plate 160. The light source 160 may generate light at a high efficiency and a low power.

The chassis 170 is a board for connecting various components, and has various modules or speaker mounted thereon.

The reinforcement member 180, arranged between the bezel 111 and the cover 112, hides a joint between the bezel 111 and the cover 112.

The display panel 200 may include a liquid crystal panel, data drivers, and gate drivers. The display panel 200 may produce an electric field based on signals received from the data driver and the gate driver, the electric field changing an orientation angle of liquid crystals, thereby outputting a desired image.

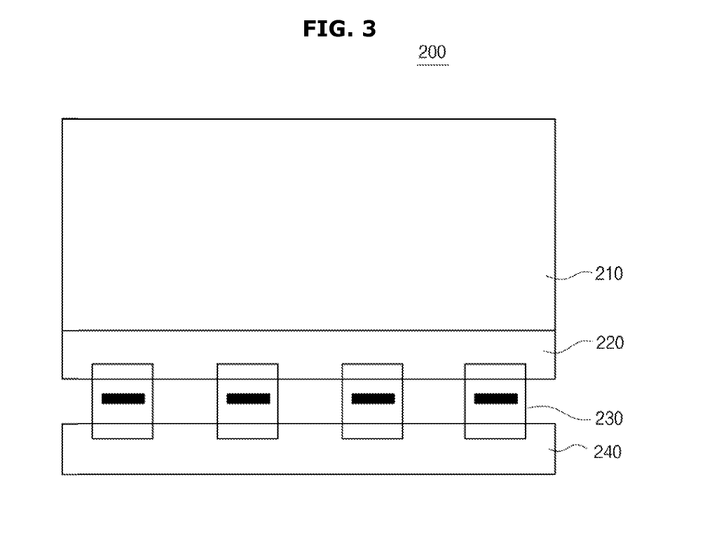

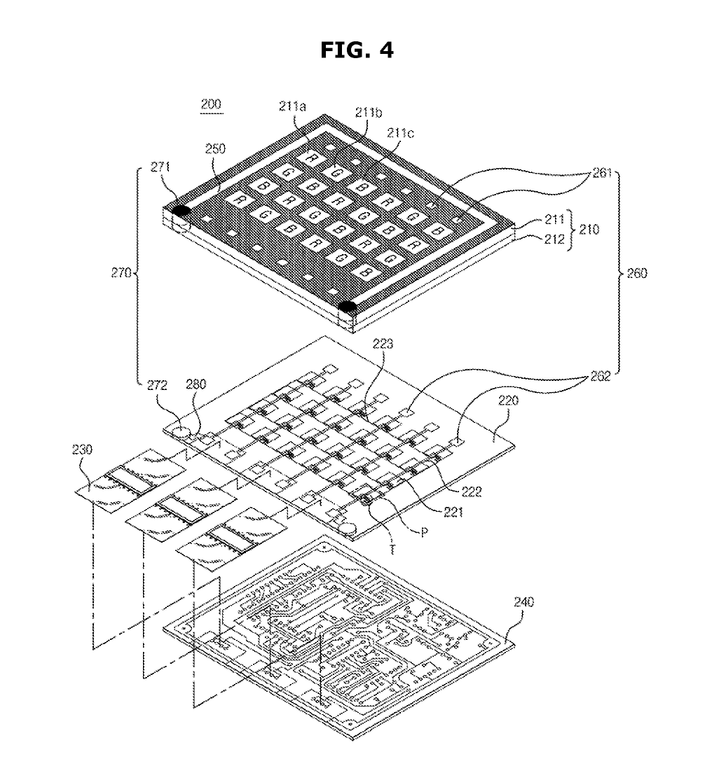

Operations of the display panel 200 will now be described in connection with FIGS. 3 and 4.

FIG. 3 schematically illustrates the display panel 200 of a display device, according to an exemplary embodiment, and FIG. 4 is an exploded view of the display panel 200, according to an exemplary embodiment.

As shown in FIG. 3, the display panel 200 may include a liquid crystal panel having first and second substrates 210 and 220 that face each other so as to fill liquid crystals therebetween; a print circuit board (PCB) 240 coupled to an edge of the liquid crystal panel 200 via a plurality of Chip On Films (COFs) 230 having data drivers and gate drivers mounted thereon; and a backlight located in the rear of the liquid crystal panel 200 to supply light.

As shown in FIG. 4, a face of the second substrate 220 has a plurality of intersecting data wirings 222 and gate wirings 223, thereby forming a plurality of pixel regions P. Thin film transistors T are located at intersecting points of the two wirings, and correspond one to one with and connect to transparent pixel electrodes 221 included in the pixel regions P.

The first substrate 210 is formed opposite the second substrate 220. Liquid crystals are filled between the first and second substrates 210 and 220.

On a face of the first substrate 210, black matrices are formed in a grid to encircle pixel regions P such that non-display elements like the data wirings 222, gate wirings 223, and thin film transistors T on the second substrate 220 are blocked from view, and the pixel electrodes 221 are not blocked from view.

Color filters, e.g., red, green and blue color filters 211a, 211b, and 211c, are sequentially and repeatedly arranged in the grid to correspond to respective pixel regions P, and a transparent common electrode 212 that covers the color filters, are included.

Furthermore, top and bottom alignment layers that determine initial molecule arrangement and orientation of the liquid crystals are interposed around boundaries of the first and second substrates 210 and 220, and the liquid crystals are filled therebetween. A seal pattern is formed along the edge of the first and second substrates 210 and 220 to prevent leakage of the liquid crystals. Polarizing plates for selective transmission of a particular ray may be attached to respective external faces of the first and second substrates 210 and 220.

The data wirings 222 and gate wirings 223 of the second substrate 220 may be connected to the PCB 240 via the COFs 230. On the PCB 240, there may be a timing controller, a power source, a gamma voltage generator, etc., that may generate a voltage signal required for image rendering by primarily processing a variety of signal information input from an external device, like a computer.

The COFs 230 have data drivers for generating data signals with the signal voltage applied from the PCB 240. The COFs 230 may also have gate drivers for providing gate signals to the gate wirings 223.

As such, gate signals may be provided to the gate wirings 223 of the liquid panel. The thin film transistors may be selectively turned on/off by the gate signals, and data signals are provided to pixel electrodes 221 corresponding to turned-on thin film transistors. Electric fields may be produced by data signals provided to the pixel electrodes 221 and a voltage applied to the common electrode 212, causing an orientation angle of the liquid crystals between the pixel electrodes 221 and the common electrode 212 to change. Light transmittance may be controlled based on the orientation angles of the liquid crystals, and therefore the orientation angles of the liquid crystals may be used to output a desired image.

In the meantime, an external surge voltage applied to the display device may degrade performance of the display device. The surge voltage may be, e.g., a voltage generated by an Electro Static Discharge (ESD). The ESD refers to static electricity induced by a human or an object. Components of the display device may be easily damaged by a high voltage applied to the display device due to the static electricity. If the high voltage is applied to the pixel regions, a desired image may not be output on the screen.

Accordingly, the display device may be configured to block such a surge voltage from being applied to the pixel regions.

As shown in FIG. 4, the display device may have a first ground wiring 250 formed on the first plate 210 to block an external surge voltage from being applied to the pixel regions. The first ground wiring 250 may block the surge voltage from being applied to the pixel regions by absorbing the surge voltage. The first ground wiring 250 may be formed of a conductive material, so as to easily absorb the surge voltage.

Referring to FIG. 4, the first ground wiring 250 formed of the conductive material may be attached onto a face of the first substrate 210.

The first ground wiring 250 may be formed along the edge of the first substrate 210. This configuration allows the surge voltage to be absorbed by the first ground wiring 250 before being applied to the first substrate 210.

The edge of the first substrate 210 refers to an area between the boundary of the first substrate 210 and short points 260. Short points 260 may refer to points at which the common electrode of the first substrate 210 and the pixel electrodes of the second substrate 220 are electrically connected, and include first short points 261 formed on the first substrate 210 and second short points 262 formed on the second substrate 220 electrically coupled to the first short points 261.

If the first ground wiring 250 becomes short-circuited with the short points 260, a surge voltage absorbed by the first ground wiring 250 may be applied, through the short points 260, to the pixel electrodes of the second substrate 220. In this case, desired electric fields may be interfered with, thus causing a problem outputting a desired image.

Accordingly, the first ground wiring 250 should be spaced apart from the short points 260. Specifically, as shown in FIG. 4, the first ground wiring 250 may be formed closer to the boundary of the first substrate 210 than to the short points 260.

Furthermore, the first ground wiring 250 may be formed closer to the boundary of the first substrate 210 than to a location of the first substrate 210 that corresponds to a location where a sealant is formed on the second substrate 220.

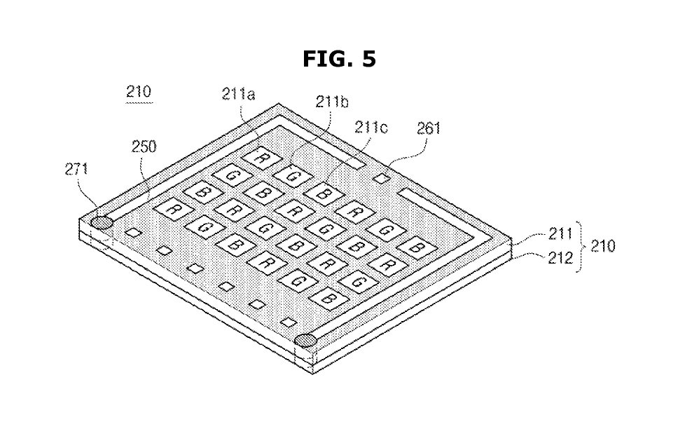

FIG. 5 is a perspective view of the first substrate 210 of a display panel of a display device, according to another exemplary embodiment of the present disclosure.

As shown in FIG. 5, since there is a short point 261 in a path of the first ground wiring 250, there is a need to isolate the first ground wiring 250 not to be short-circuited with the first short point 261.

Turning back to FIG. 4, the display device may include ground short points 270 that deliver a surge voltage absorbed by the first ground wiring 250 to the second substrate 220. The ground short points 270 may include first ground short points 271 formed on the first substrate 210, and second ground short points 272 formed on the second substrate 220 to be coupled to the first ground short points 271.

The ground short points 270 may be formed on ends of the first ground wiring 250. There may be one or more ground short points 270.

In addition, the display device may further include a second ground wiring 280 that connects ground electrodes of data drivers and the ground short points 270. Ground electrodes of the data drivers refer to parts of the data drivers for receiving data signals when the data signals generated from the data drivers flow back to the data drivers through the data wirings 222. By connecting the ground electrodes of the data drivers and the ground short points 270, there is no need for a separate ground to discharge the surge voltage.

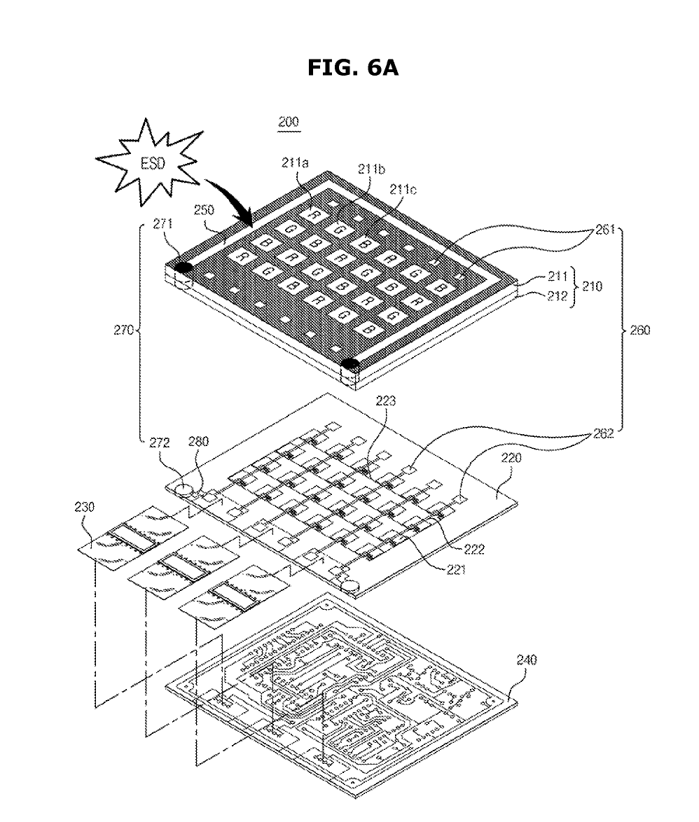

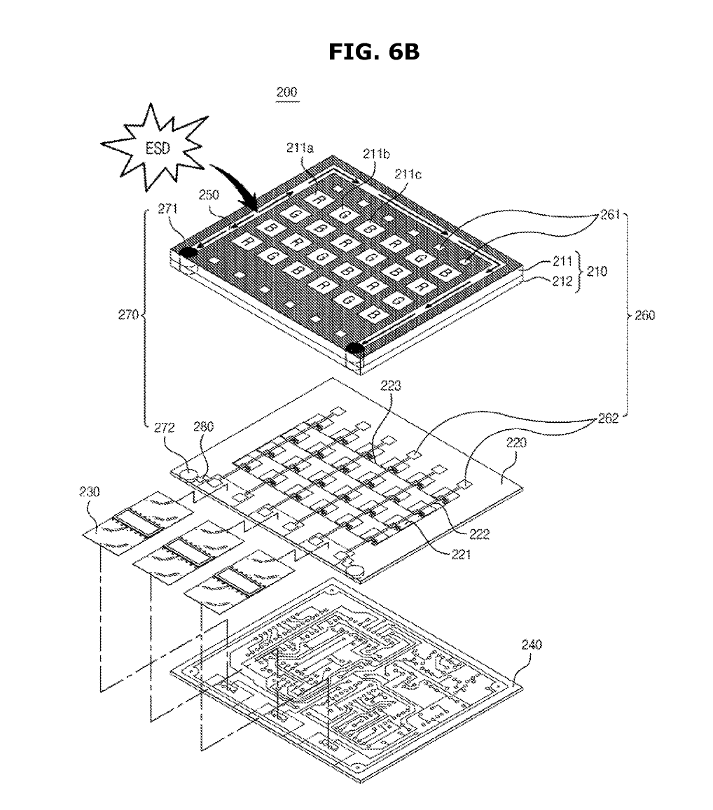

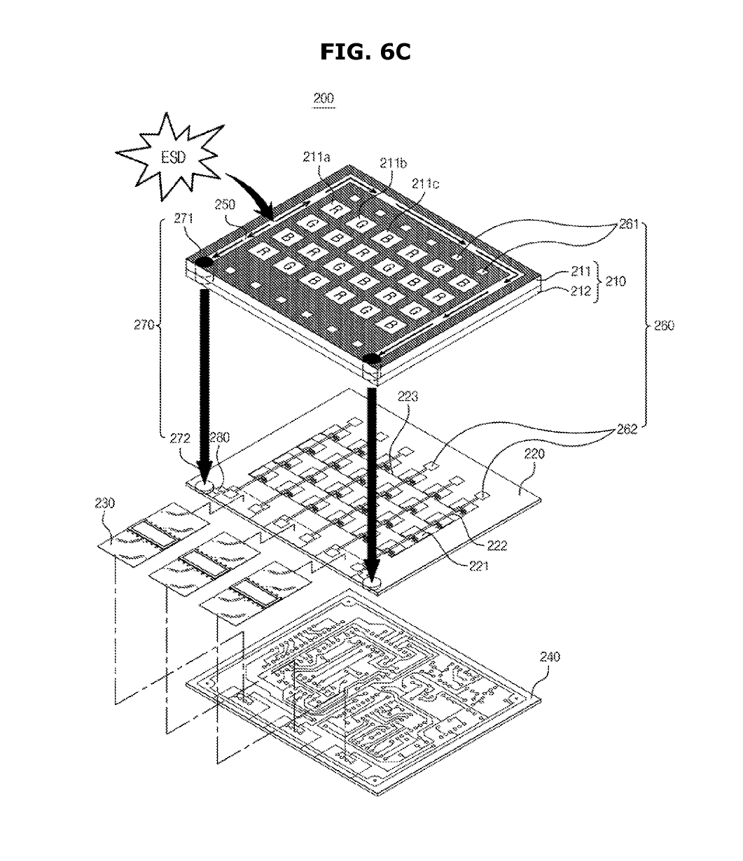

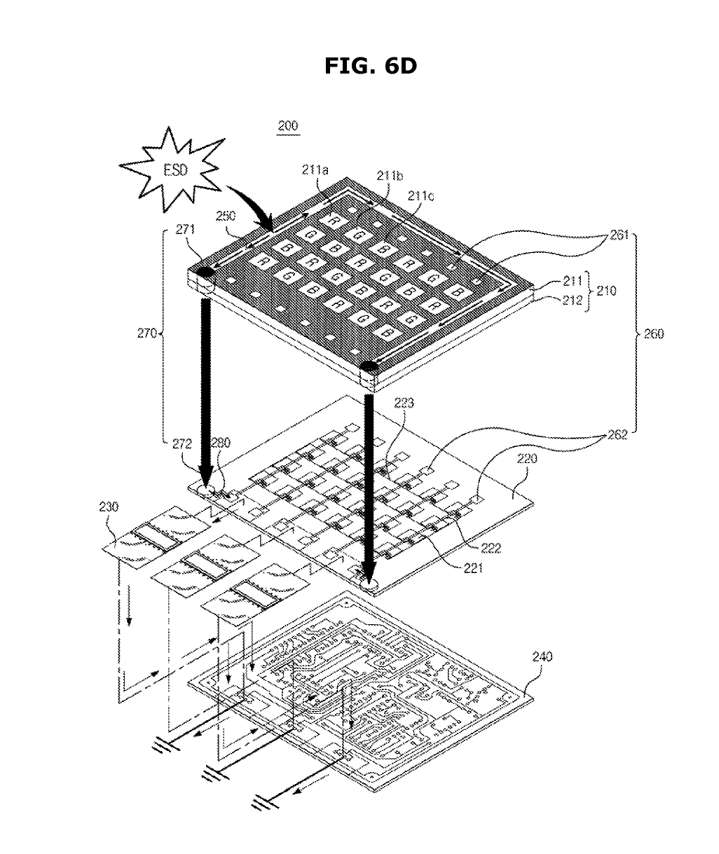

FIGS. 6A to 6D illustrate exploded views of a display panel and a path through which a surge voltage is discharged.

As shown in FIG. 6A, an external surge voltage may be generated. The surge voltage may be static electricity, for example.

Because the surge voltage may damage the display device, especially pixel regions, there is a need to block the surge voltage from being applied to the display device. As shown in FIG. 6B, forming the first ground wiring 250 on the first substrate 210 may block the surge voltage from being applied to the pixel regions. The first ground wiring 250 may be formed of a highly conductive material having a very low resistance, so as to absorb the surge voltage.

As shown in FIG. 6C, the surge voltage absorbed by the first ground wiring 250 may be delivered to the second substrate 220 through the ground short points 270. The ground short points 270 may be formed on ends of the first ground wiring 250, but are not limited thereto, so long as they deliver the surge voltage absorbed by the first ground wiring 250 to the second substrate 220. Also, there may be any number of the ground short points 270.

Specifically, the ground short points 270 may include first ground short points 271 formed on the first substrate 210, and second ground short points 272 formed on the second substrate 220 to be coupled to the first ground short points 271. Accordingly, the surge voltage absorbed by the first ground wiring 250 may be delivered to the first ground short points 271, then to the second ground short points 272, and then to the second substrate 220.

Finally, the surge voltage may be delivered to the data drivers on the second substrate 220 and then discharged. This may be possible by forming the second ground wiring 280 that connects the second ground short points 272 and ground electrodes of data drivers, as shown in FIG. 6D. The surge voltage delivered to the second ground short points 272 may be applied along the second ground wiring 280 to the data drivers through the ground electrodes of the data drivers.

In this regard, as shown in FIG. 6D, the data drivers may be mounted on the COFs 230.

The data drivers may discharge the surge voltage by sending the surge voltage to the PCB 240.

Although the first ground wiring 250 attached to the first substrate 210 has thus far been described, according to various exemplary embodiments, the first ground wiring 250 may be formed by patterning on the first substrate 210 in other exemplary embodiments.

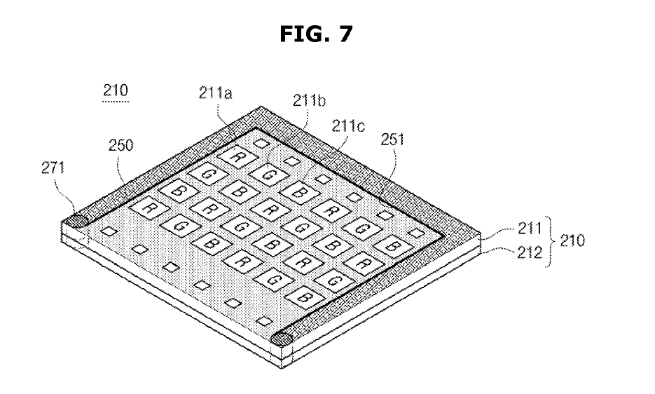

FIG. 7 is a perspective view of the first substrate 210 of a display panel of a display device, according to another exemplary embodiment of the present disclosure.

As shown in FIG. 7, the first substrate 210 may include a common electrode 212 to which a voltage is applied. By patterning along the boundary of the common electrode 212, the first ground wiring 250 may be formed.

With the first ground wiring 250 formed by patterning on the common electrode 212, there is no need for a separate process of attaching the first ground wiring 250 to the first substrate 210. This may simplify the manufacturing process of the display device, and reduce the manufacturing cost.

On the first substrate 210, an isolator 251 for blocking the first ground wiring 250 formed by patterning and the common electrode 212 may be formed. The common electrode 212 may be formed so that a voltage may be applied to the first substrate 210, thereby producing electric fields from relationships with pixel electrodes 221 of the second substrate 220. In order for the common electrode 212 and the pixel electrodes 221 to normally produce electric fields, there is a need to block an external surge voltage from being applied to the common electrode 212. Therefore, the isolator 251 may be formed on the boundary of the first ground wiring 250 formed by patterning, thereby electrically blocking the common electrode 212 and the first ground wiring 250.

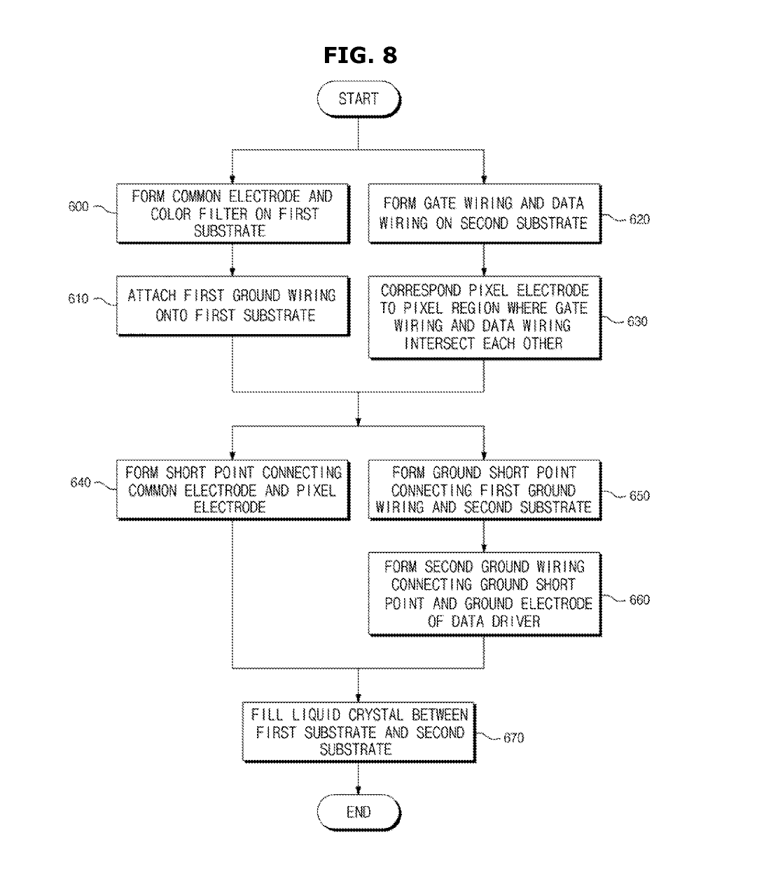

FIG. 8 is a flowchart illustrating a method for manufacturing a display device, according to an exemplary embodiment of the present disclosure.

In operation 600, on the first substrate 210, a common electrode 212 to which a voltage is applied may be formed. In operation 600, on the first substrate 210, color filters 211 may be formed as well.

Furthermore, in operation 610, a first ground electrode may be attached onto the first substrate 210. The first ground electrode may be formed on the first substrate 210 not short-circuited with the short points 260. Specifically, the first ground electrode may be formed along the boundary of the first substrate 210.

While the first ground electrode is formed after the common electrode 212 and color filters are formed on the first substrate 210 in the exemplary embodiment of FIG. 8, according to other exemplary embodiments the first ground electrode may be formed first or simultaneously.

In operation 620, on the second substrate 220, a plurality of intersecting gate wirings 223 and data wirings 222 are formed. In operation 630, pixel regions may be formed at intersections of the gate wirings 223 and data wirings 222 and pixel electrodes 221 may be formed to correspond to the pixel regions.

After this, the first and second substrates 210 and 220 may be coupled electrically.

Specifically, in operation 640, short points 260 may be formed to connect the common electrode 212 of the first substrate 210 and pixel electrodes 221 of the second substrate 220. Even if a voltage is applied through one path, the short points 260 may enable the voltage to be applied to the first and second substrates 210 and 220.

In addition, in operation 650, ground short points 270 may be formed to connect the first ground wiring 250 of the first substrate 210 and the second substrate 220. Through the ground short points 270, the surge voltage absorbed by the first ground wiring 250 may be delivered to the second substrate 220.

In operation 660, the second ground wiring 280 that connects the ground short points 270 and the ground electrodes of the data drivers may be formed. The surge voltage delivered to the second substrate 220 may be delivered along the second ground wiring 280 to the data drivers to be discharged.

As such, after the first and second substrates 210 and 220 are electrically coupled, in operation 670, liquid crystals may be filled between the first and second substrates 210 and 220. The liquid crystals control output of a desired image rotating due to the electric fields produced by the first and second substrates 210 and 220.

According to another exemplary embodiment, the second substrate 220 may be formed first, liquid crystals may be formed as a layer, and then the second substrate 220 may be formed on top of the liquid crystal layer. Consistent with an exemplary embodiment, the manufacturing method of the display device may be implemented in various ways.

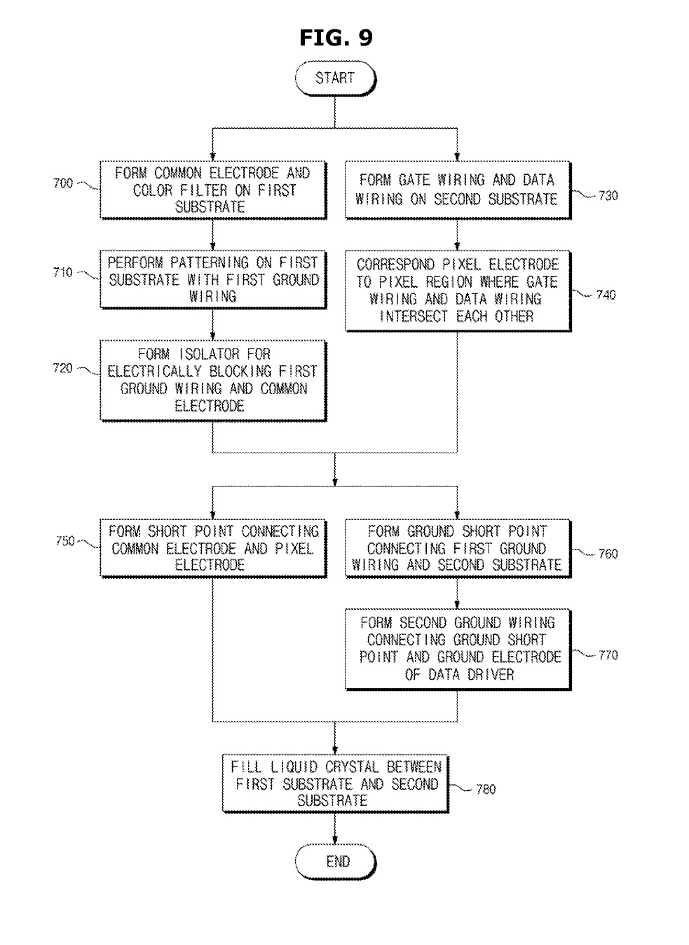

FIG. 9 is a flowchart illustrating a method for manufacturing a display device, according to another exemplary embodiment.

First, in operation 700, on the first substrate 210, a common electrode 212 and color filters may be formed.

In operation 710, by patterning on the common electrode 212, the first ground wiring 250 may be formed. While the first ground wiring 250 is attached onto the first substrate 210 in the exemplary embodiment of FIG. 8, according to other exemplary embodiments the first substrate 210 may be formed differently by means of the common electrode 212 in other exemplary embodiments.

In operation 720, after the first ground wiring 250 is formed by patterning, an isolator 251 for electrically blocking the first ground wiring 250 and the common electrode 212 may be formed. In this regard, the isolator 251 may be formed by etching the common electrode 212.

With the isolator 251, a surge voltage absorbed by the first ground wiring 250 formed by patterning may be prevented from reaching the common electrode 212 and is discharged through other paths.

Similar to operation 620, in operation 730, a plurality of gate wirings 223 and data wirings 222 are formed on the second substrate 220. Similar to operation 630, in operation 740 pixel electrodes 221 are formed to correspond to pixel regions where the plurality of gate wirings 223 and data wirings 222 intersect each other.

Operations 750, 760 and 770 where the first and second substrates 210 and 220 are electrically coupled and operation 780 where liquid crystals are filled between the first and second substrates 210 and 220 are also the same as described in FIG. 8, so the description will be omitted.

In accordance with the exemplary embodiments of the present disclosure, static electricity may be blocked from being input to pixel regions by having a ground wiring absorb the static electricity.

Furthermore, the ground wiring is less likely to be short-circuited with data wirings or gate wirings by forming the ground wiring in a substrate that includes color filters.

Several exemplary embodiments have been described, but a person of ordinary skill in the art will understand and appreciate that various modifications can be made without departing the scope of the present disclosure. Thus, it will be apparent to those ordinary skilled in the art that the disclosure is not limited to the exemplary embodiments described, which have been provided only for illustrative purposes.

What is claimed is:

1. A display device comprising:
a first substrate and a second substrate formed to face each other;
a liquid crystal layer between the first substrate and the second substrate;
a plurality of gate wirings and data wirings intersecting each other to form a plurality of pixel regions on the second substrate; and
a first ground wiring formed on the first substrate configured to block a surge voltage from being applied to the pixel regions.

2. The display device of claim 1, wherein the first ground wiring is formed along an edge of the first substrate.

3. The display device of claim 1, wherein the first substrate comprises a common electrode configured to receive a voltage,
wherein the second substrate comprises a plurality of pixel electrodes formed in the pixel regions and configured to produce electric fields with the common electrode, and
wherein the display device further comprises a plurality of short points for connecting the common electrode and the pixel electrodes.

4. The display device of claim 3, wherein the first ground wiring is formed closer to the edge of the first substrate than to the short points.

5. The display device of claim 3, wherein the first ground wiring is formed by patterning along the edge of the common electrode.

6. The display device of claim 5, wherein the first substrate comprises an isolator configured to isolate the first ground wiring from the common electrode.

7. The display device of claim 1, wherein the first ground wiring is configured to absorb the surge voltage.

8. The display device of claim 7, further comprising:
ground short points configured to deliver the surge voltage absorbed by the first ground wiring to the second substrate.

9. The display device of claim 8, further comprising:
data drivers connected to the plurality of data wirings configured to provide data signals to the plurality of data wirings; and
a second ground wiring that connects ground electrodes of the data drivers and the ground short points.

10. The display device of claim 7, wherein the first ground wiring is connected to a plurality of ground electrodes of the data drivers.

11. A manufacturing method of a display device comprising:
filling a liquid crystal layer between a first substrate and a second substrate comprising pixel regions; and
forming, on the first substrate, a first ground wiring configured to block an external surge voltage from being applied to the pixel regions.

12. The manufacturing method of a display device of claim 11, wherein the forming the first ground wiring comprises:
forming the first ground wiring along an edge of the first substrate.

13. The manufacturing method of a display device of claim 11, further comprising forming short points for connecting a common electrode and the pixel electrodes,
wherein the first substrate comprises the common electrode to which a voltage is applied and the second substrate comprises pixel electrodes formed in the pixel regions to produce electric fields with the common electrode.

14. The manufacturing method of a display device of claim 13, wherein forming the first ground wiring comprises:
forming the first ground wiring along an edge of the first substrate closer to the edge than to the short points.

15. The manufacturing method of a display device of claim 13, wherein forming the first ground wiring comprises:
patterning along the edge of the common electrode.

16. The manufacturing method of a display device of claim 15, wherein forming the first ground wiring comprises:
forming an isolator configured to isolate the first ground wiring and the common electrode.

17. The manufacturing method of a display device of claim 11, wherein forming the first ground wiring comprises:
forming the first ground wiring to absorb the surge voltage.

18. The manufacturing method of a display device of claim 17, further comprising:
forming ground short points configured to deliver the surge voltage absorbed by the first ground wiring to the second substrate.

19. The manufacturing method of a display device of claim 18, further comprising:
forming, on the second substrate, data drivers configured to provide data signals to the pixel regions; and
forming a second ground wiring that connects ground electrodes of the data drivers and the ground short points.
